(19) United States
(12) Patent Application Publication
(10) Pub. No.: US 2023/0196780 A1
(43) Pub. Date: Jun. 22, 2023

(54) SYSTEMS AND METHODS FOR ELECTRONIC SURVEILLANCE

(71) Applicant: Selex ES Inc., Greensboro, NC (US)

(72) Inventors: Willem Nieuwkerk, Greensboro, NC (US); Todd Child, Greensboro, NC (US)

(21) Appl. No.: 18/072,924

(22) Filed: Dec. 1, 2022

Related U.S. Application Data
(60) Provisional application No. 63/292,111, filed on Dec. 21, 2021.

(51) Int. Cl. G06V 20/52; G06V 20/62; G08B 25/01

(52) U.S. Cl. CPC G06V 20/52; G06V 20/625; G08B 25/016

(57) ABSTRACT

A system and method for monitoring for one or more electronic signals associated with one or more selected locations. In an embodiment, the system may include collection devices positioned at selected locations. The collection devices may include (1) at least one sensor or (2) at least one antenna configured to collect, via a corresponding frequency, electronic signals from proximal electronic devices. The collection devices may include a communication circuitry to transmit collected electronic signals. The system may include an intelligence device positioned separate from the collection devices. The intelligence device may include a database and a correlation circuitry to determine a correlation of one or more different electronic signals of the collected electronic signals and one or more targets based upon a comparison of the collected electronic signals with one or more electronic signatures associated with one or more targets.

The present Patent application claims the benefit of U.S. Provisional Application No. 63/292,111, filed Dec. 21, 2021, titled “SYSTEMS AND METHODS FOR ELECTRONIC SURVEILLANCE”.

### INCORPORATION BY REFERENCE

The disclosures made in U.S. Provisional Application No. 63/292,111, filed Dec. 21, 2021, are specifically incorporated by reference herein as if set forth in its entirety.

### TECHNICAL FIELD

In one aspect, the present disclosure is directed to surveillance systems and methods, and more specifically, to surveillance systems and methods that facilitate collection and correlation of electronic signatures and/or visual identifiers for targets or convoys captured proximate to a home, a business, and/or a neighborhood or specified area. Other aspects also are described.

### BACKGROUND

A large number of homes and businesses now include many devices that utilize Wi-Fi and/or Bluetooth signals. Further, use of home security cameras and/or doorbell cameras has become more common among large portions of the population. While, the cameras can capture images and/or video, the cameras cannot identify people who are obscured, masked, or otherwise attempt to hide their identity. Finally, most people carry at least one electronic device regularly, e.g., a smartphone.

It can be seen that a need exists for surveillance systems and methods that can be used to provide a correlation between devices, images, and/or locations, thus enabling tracking of unidentified persons at or near a home, a business, or a neighborhood.

The present disclosure is directed to the foregoing and other related, and unrelated, problems in the relevant art.

### SUMMARY

Briefly described, the present disclosure is directed to surveillance systems and methods for collecting electronic signatures and/or images, for identification of targets, such as unidentified persons or vehicles within a prescribed or selected location or area. Further, electronic signatures and/or images may be correlated thus enabling monitoring and potential identification of unidentified persons or vehicles.

According to aspects of the present disclosure, the surveillance system is configured to utilize existing Wi-Fi connectivity of homes, businesses, and other locations by placing collection devices, including a plurality of sensors, detectors or other, similar devices, positioned at tactical locations on a property. Each of the collection devices will be configured to collect electronic signals within a collection range of the premises for the purpose of correlating those signals with other collected signals and patterns to identify a target or targets that may have been present. The collection devices each may be an independent device, or can be linked to other collection devices in a network or an array, and further may be integrated into other home automation, convenience, or other electronic devices. Examples include integration with video doorbell systems; video surveillance systems; alarm components; mailbox sensors; exterior lighting and/or motion detection systems; garage, door and gate activation pads or openers, neighborhood watch systems, etc. . . .

In embodiments, collected electronic signal data obtained by the collection devices may be filtered locally and sent to a central database system for storage and correlation processing. In embodiments, the database and/or resulting correlation information could be made available to law enforcement for processing. The collected data generally will be individually anonymous, e.g., unlike a video or photograph of a person, etc., the collected data is directed to features of the captured electronic signals with ‘rolling’ identifiers that are intended to be variable. The surveillance system will include programming, including models configured for cluster and pattern analysis, which, in embodiments of the present disclosure, provide a central capability to identify certain electronic devices and targets (e.g., vehicles, individuals, etc.). Signals and signal characteristics can be used individually or in combination with adjacent signals to uniquely identify a source for correlation with and identification of targets.

Such surveillance systems and methods may include one or more collection devices positioned at one or more selected locations. Each of the one or more collection devices may include one or more antennas configured to detect and receive electronic signals from electronic devices using a corresponding frequency. In embodiments, each of the one or more collection devices also may include communications circuitry for transmitting collected electronic signals to an intelligence device that may include communications circuitry to receive any detected electronic signals and/or other data (e.g., images, a series of images, video, location data, license plate numbers, and/or other data related to potential targets). The intelligence device will be configured and/or will include programming configured to analyze the received data.

The electronic signals included within the received data may include tags identifying a type of electronic device that the signal originated from, as well as a number of times and a length of time that the signal is located within a particular area. The tags may also indicate whether signal is not typically located in that particular area. The intelligence device can correlate unidentified and/or atypical electronic signals and/or other data with electronic signals typically found in the area. The intelligence device may then determine whether the unidentified and/or atypical electronic signals and/or other data is correlated with a particular target, convoy, or person based on data from other locations or areas. Thus, a target, convoy, or person can be tracked and/or associated with events in selected areas or locations.

According to aspects of the present disclosure, a surveillance system is provided, which includes collection systems, devices, or assemblies, and an intelligence system having classification and search capabilities. In embodiments, the surveillance system will use the characteristics of the collected identifying characteristics to prioritize or otherwise indicate to an investigator that a particular characteristic is material to the identification of the target of an investigation in a particular area or location (e.g., a home, a neighborhood, and/or a business).

In embodiments, a method is provided that can use correlation statistics and analysis to develop relationships between identifiers and non-unique characteristics over a single encounter (e.g., an atypical electronic device located in a selected area during a particular event) or multiple encounters. No single factor is required to be an absolute or unique identifier. One or more combinations of non-unique characteristics and broadcast or visible variables, methods and transmitted values can be used to identify a set that are collectively statistically significant in their unique association with the source area or location. In embodiments, this method may use artificial intelligence and “Big Data” techniques to identify correlations and to rank those results based on statistical methods created in expert noise reduction and confidence analysis.

In embodiments, the surveillance system can include a plurality of collection systems, devices, or assemblies that are located at selected geographic areas or strategic locations. The collection systems generally are configured to capture or facilitate collection of information related to visual identifiers and/or electronic signatures associated with and/or atypical to the selected areas/locations. For example, the collection devices can include purpose-built collection hardware, additional antennae and radio hardware that can be integrated into existing Wi-Fi platforms at a home or business to allow collection of passing, approaching and/or entering individuals that can be time and location correlated across the collection. Placing sensors in locations where people are already aware of and/or are comfortable with cameras and surveillance would allow sensing and recording of approach and home access.

In embodiments, the collection systems can include at least one sensor configured to collect or otherwise capture electronic signal information related electronic signatures of targets and/or electronic devices. This information further can include visual identifiers such as license plate information or other visual or imaged information associated with vehicles (e.g., stickers, patterns, position(s) of component parts, after-market added parts, damage, and/or various other markings, etc. . . . ) that can be used to distinguish or otherwise identify, detect or discern a target vehicle; and/or images or a series of images, such as photographs or video captured by security cameras and/or doorbell cameras. The electronic signatures can include an electronic signal or combination(s) of electronic signals emanating from transmitting electronic devices, and which are associated with and/or can uniquely identify the targets in or moving about the selected areas/locations, such as cell phones, laptops, computing devices, garage door openers, home automation devices, security panels, security cameras, doorbell cameras, key fobs for a vehicle, and/or other electronic devices emitting a wireless signal. The data collected from any of the devices may be tagged. The tags may include the type of device and whether the device is typical or atypical to the selected location.

In addition, in some aspects, the surveillance system can include an intelligence device or system that is in communication with the plurality of collection systems, and will be configured to receive the information collected or captured by the collection systems or devices (e.g., data points or packets of time and date stamped information in real time for targets within proximity of the collection point systems), and will further be configured (e.g. including programming, etc.) to identify and/or track the atypical targets and/or electronic devices based on this received information. In embodiments, the intelligence system can include classification and search capabilities, for example, including one or more classification and search engines and an intelligence database in communication therewith. The one or more classification and search engines can be configured to identify or extract the electronic signatures associated with the targets using the information collected by the collection systems and catalogue them in the intelligence database with a number of occurrences or discoveries and/or certain identifying characteristics (e.g., geographical coordinates, time stamps, source manufacturer, source type and unique ID, etc.) allowing these identified electronic signatures to become unique, identifiable, individually searchable, and/or searchable in combination with other electronic signatures or targets (e.g., such as in a convoy search).

The surveillance system thus is configurable to track, map, catalogue, etc., movements of atypical targets (e.g., atypical to a selected area or location) in real time or historically as electronic signals emanating in proximity to the collection systems or devices at one or more selected areas or locations. The tracking information generated can be used to help confirm and/or authenticate potential target identification, and further can be configured to generate alerts or notifications when certain targets or atypical targets are in proximity to the collection systems during an event.

The one or more classification and search engines can develop inferences of relationships between electronic devices and targets typical to an area or location and electronic devices and targets atypical to an area based on consistency and/or frequency of detected correlations between identified/extracted electronic signatures and/or targets. Further, the one or more classification and search engines can base such relationships on a reported event or alert, such as a crime or other events.

For example, the one or more classification and search engines can use frequency and consistency of electronic signals to determine the relative certainty of association of the transmitted electronic devices and targets to develop electronic signatures of the targets. That is, if the relative certainty or probability that a certain electronic signal or combination of electronic signals are associated with a target meets a prescribed threshold, the one or more classification and search engines can identify an electronic signal or combinations of electronic signals as a specific electronic signature associated with that target. Further, the one or more classification and search engines can use frequency and consistency of captured images of different targets traveling together to develop a correlation between different targets. That is, if the relative certainty or probability that a certain first target travels with a second target meets a prescribed threshold, the one or more classification and search engines can identify one or more targets, e.g., first and second targets and/or others, as associated with a convoy. The term “convoy” generally refers to a group of or two or more targets that travel together one or more times on one or more days (e.g., two vehicles that travel together at a specific time on various days). In such embodiments, a convoy may be generated based on electronic signals and/or targets usually found in a selected area. Different or atypical electronic signals and/or targets may be distinguished based on exclusion in existing convoys.

In an embodiment, the one or more classification and search engines will be configured to correlate one or more identifying characteristics and/or non-unique characteristics over single encounter or multiple encounters. The one or more identifying characteristics may include license plates, electronic signals, images, a series of images, and/or visual idiosyncrasies, among other factors. Non-unique characteristics may include vehicle make, vehicle model, vehicle color, vehicle year, articles of clothing, among other non-unique characteristics and/or personal characteristics. Such correlations may be determined via machine learning models or classifiers and/or statistical modeling or analysis. The one or more classification and search engines may utilize such correlations to determine various aspects of a target, such as a potential association or correlation between a target and an event in a selected location, among other aspects. Further, the one or more classification and search engines may be utilized to determine statistically significant correlations or associations between atypical targets or atypical electronic signals and/or electronic signals.

In an embodiment, the one or more classification and search engines will be configured to analyze correlation results using frequency of occurrence, relative representation, signal type, signal receipt location diversity, and signal strength profiling to generate and present confidence levels and/or rankings for correlations between signal-receipt events. The one or more classification and search engines may be configured to filter and sort results such that the user is directed to signals to be associated with a particular event or alarm.

In an embodiment, the systems and methods may include filtering in-coming electronic signals to maximize the receipt and storage of moving, stable, identifiable signals by analyzing the signal value, strength, spectrum, and embedded identification data. The systems and method may also simultaneously reduce and filter signals and identifiers that are ‘noise’ from likely-unrelated sources and not relevant to the future correlation.

In addition, or in the alternative, the one or more classification and search engines will be configured to associate or correlate identifying atypical electronic signatures with visual identifiers and frequent electronic signatures at a selected location, such as a visual vehicle identifier, to allow independent identification, tracking, and location identification of targets based on the associated identifying electronic signatures. That is, once the system has records correlating electronic signatures associated with a specific visual vehicle identifier, e.g., a specific license plate number, the intelligence system will be able to detect the likely presence of a vehicle and its associated license plate without visual information, e.g., without the use of a camera. Further, correlation between two or more targets may allow dependent tracking and location identification of targets based on associated or correlated one or more targets. That is, once the system has records correlating a first target with a second target (or more targets), the intelligence system will be able to determine likely presence of the first target based on visual information and/or electronic signals of the second or more targets.

Furthermore, the collection systems can be placed in locations or areas nearby homes, neighborhoods, and/or businesses, such that the intelligence system will be able to identify, and catalogue known electronic signatures and targets in selected areas, e.g., for tracking, mapping, etc. of persons or electronic devices atypical or different than that of persons or electronic devices usually found in the selected areas.

In embodiments, the at least one sensor of each collection system can include a plurality of sensor assemblies. The sensor assemblies can include one or more cameras or camera systems configured to capture or facilitate collection of information related to vehicle identifiers, such as visual information related to a license plate of a vehicle or other visual vehicle identifiers.

In addition, the sensor assemblies can include one or more antennas or other signal receivers configured to capture information related to the electronic signatures. The one or more antennas can include a plurality of antennas, such as a Bluetooth® antenna, a Wi-Fi antenna, a RFID antenna, or other RF antennas or combinations thereof, configured to capture information related to electronic signals associated with the targets.

In some embodiments, the collection systems can be used in conjunction with or include Automated License Plate Readers (“ALPR”) in certain areas, allowing the intelligence system to develop a subset of electronic signals, i.e., an electronic signature, associated with a license plate read at a moment in time and location. Electronic data points from less expensive collectors can then be used to provide more precise tracking than ALPR alone.

In some embodiments, the surveillance system can be configured to capture sample electronic signature information from a target and/or visual identifiers of other targets, associate that information with the target's identification, and then search for or alert on receipts of similar electronic signature information at one of the collection point systems.

In additional embodiments, the surveillance system can be configured to allow for search inquiries or scans of suspect's electronic signatures to search selected locations in the database history, placing the suspect at those locations and at a particular time or times. In such examples, the surveillance system can include a user interface. A user can access the user interface and provide various inputs into the user interface. The inputs may include one or more of time, location, license plate numbers, partial license plate numbers, convoys, and/or data related to an event (e.g., package delivery, crime, new visitor, etc.). In such examples, the surveillance system may include text recognition algorithms to parse through text corresponding to the event and separate out important or key words, such as identifying characteristics. Upon providing the various inputs, the surveillance system may provide, as an output, information correlated to the various inputs. For example, an input may include a time, a location, and a portion of a license plate. The output may include how often a vehicle with the portion of the license plate is at that location. Such an output may be determined, at least in part, based on the correlation between that vehicle and other vehicles, electronic data signals, and/or people.

In still other embodiments, the surveillance system can be configured to allow for labeling of specific electronic signatures with a target and then alert or search for history of those specific electronic signatures in the database, placing the target at various locations.

In further embodiments, the surveillance system further can indicate or determine changes in association or travel of suspects or other individuals of interest based on variations in electronic signatures and/or correlated targets associated with a target or targets.

In further embodiments, the surveillance system further can be utilized to generate mail and package delivery notifications (e.g., including package theft), transient signal schedule tracking, regular transient signal reporting to improve bus or transport arrival or departure predictability and alerts, intrusion detection, tagged pet tracking, integrated known-visitor security and lock status-change activation, occupancy trend tracking and reporting for integrated utility and energy management, customization of entertainment and lighting systems by occupancy, simplified guest arrival and security management for commercial space rentals, hotel and campus security systems, and/or integrated video surveillance retrieval and queueing systems, etc.

According to another aspect of the present disclosure, a surveillance system may include one or more collection devices positioned proximate one or more of a home, neighborhood, or business. Each of the one or more collection devices may comprise at least one sensor, at least one antenna, or a combination thereof, each configured to collect, such as by monitoring or being configured to detect a selected or a corresponding frequency, electronic signals from proximal electronic devices. The one or more collection devices may comprise a communication circuitry to transmit collected electronic signals. The surveillance system may comprise an intelligence device positioned separate from the one or more collection devices. The intelligence device may comprise a database, and a correlation circuitry to develop an electronic signature for each of the proximal devices from which the electronic signals are collected and determine a correlation of each electronic signature and one or more locations of the one or more of the home, neighborhood, or business.

In an embodiment, the one or more collection devices may be configured to tag an electronic signal based on a type of electronic device emitting the electronic signal. The one or more collection devices may be configured to associate and include a timestamp and location data with each electronic signal.

In embodiments, the correlation circuitry may be configured to further determine a correlation between the one or more different electronic signals of the collected electronic signals and one or more identified targets. The one or more identified targets may include one or more of a convoy or a person.

In embodiments, the correlation circuitry may include one or more classification and search engines configured to identify the collected electronic signals and may compare identified collected electronic signals with one or more targets to thereby further determine the correlation of one or more different electronic signals of the collected electronic signals and one or more identified targets. The one or more classification and search engines may determine inferences of targets typical to the one or more locations and targets atypical to the one or more locations. In some embodiments, such a correlation may be based on the inferences of targets typical to the one or more locations and targets atypical to the one or more locations.

In embodiments, the determination of the inferences may be based on one or more of reported events or reported alerts. The one or more of reported events or reported alerts may include crimes and other events. In embodiments, the determination of the inferences may further be based on detection of one of one or more electronic signals more than a preselected threshold. The at least one sensor may include one or more cameras configured to capture electronic signals related to vehicle identifiers.

According to another aspect of the present disclosure, a method may include collecting, via one or more collection devices positioned proximate a home, electronic signals from proximal electronic devices positioned at one or more of within the home or proximate the home. The method may include reviewing the electronic signals for detection of noisy signals collected within the electronic signals. The method may include, in response to detection of noisy signals, removing the noisy signals of the electronic signals to thereby form filtered electronic signals. The method may include transmitting the filtered electronic signals to a database. The method may include developing an electronic signature for each of the proximal devices from which the filtered electronic signals are collected. The method may include determining a correlation between each electronic signature and one or more targets based upon a comparison of each electronic signature and one or more stored electronic signals associated with the one or more targets.

In an embodiment, the method may include, upon reception of the electronic signals, tagging each of the electronics signals based on a type of electronic device from which a corresponding electronic signal is collected.

In embodiments, the one or more targets may include one or more convoys or people. In some embodiments, the one or more different electronic signals may comprise one or more of unidentified signals or atypical signals. The method further may include tracking one or more targets based on the correlation.

Accordingly, embodiments of a surveillance system and methods, including systems and methods for facilitating collection and correlation of electronic signatures and/or visual identifiers for targets or convoys that are directed to the above discussed and other needs are disclosed. The foregoing and other advantages and aspects of the embodiments of the present disclosure will become apparent and more readily appreciated from the following detailed description, taken in conjunction with the accompanying drawings. Moreover, it is to be understood that both the foregoing summary of the disclosure and the following detailed description are exemplary and intended to provide further explanation without limiting the scope of the present disclosure.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a schematic diagram of a surveillance system according to the present disclosure.

FIG. 2, FIG. 3A, FIG. 3B, and FIG. 3C are schematic diagrams of a surveillance system according to the present disclosure.

FIGS. 4A through 4G show exemplary screen shots of an interface associated with the surveillance system according to FIG. 1, FIG. 2, FIG. 3A, FIG. 3B, and FIG. 3C.

The use of the same reference symbols in different drawings indicates similar or identical items.

### DETAILED DESCRIPTION

The following description in combination with the Figures is provided to assist in understanding the teachings disclosed herein. No attempt is made to show structural details of this disclosure in more detail than may be necessary for a fundamental understanding of the exemplary embodiments discussed herein and various embodiments in which they may be practiced. While the description is focused on specific implementations and embodiments of the teachings, and is provided to assist in describing the teachings, this focus should not be interpreted as a limitation on the scope or applicability of the teachings disclosed herein.

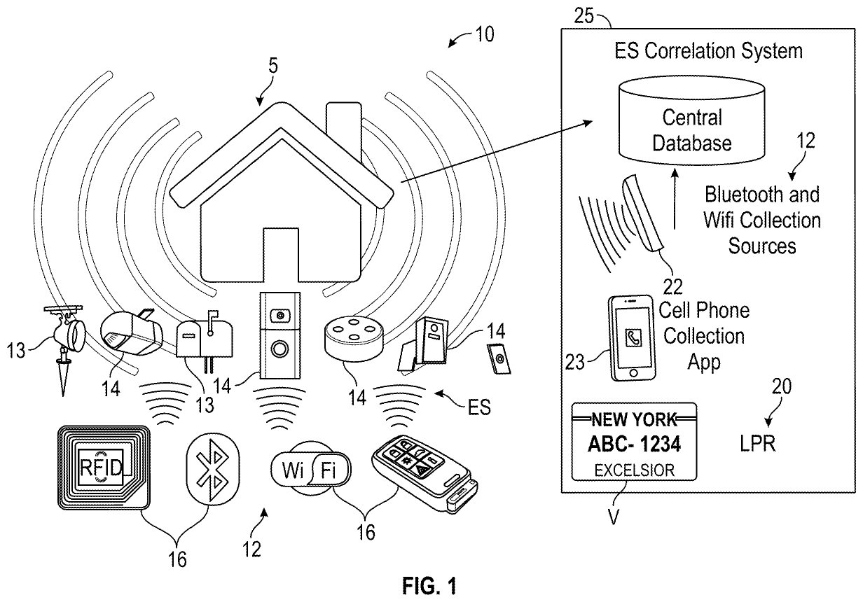

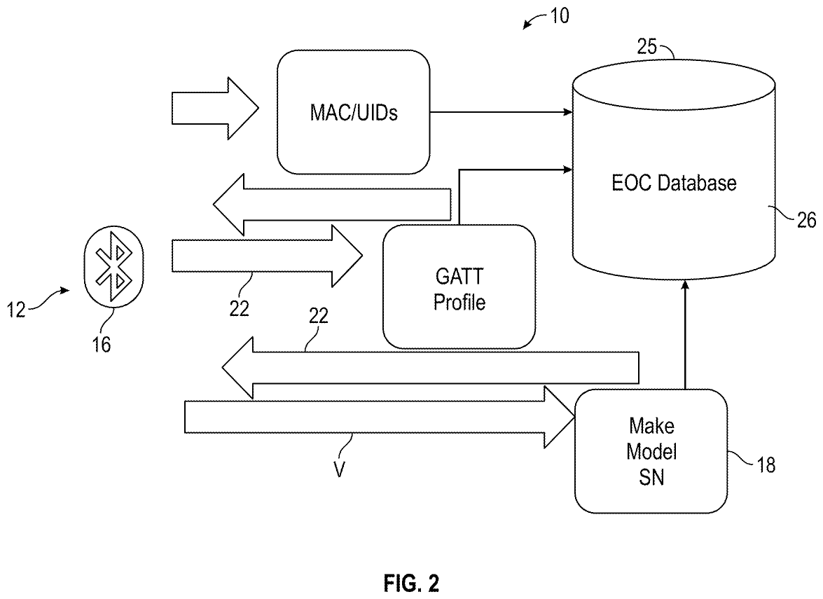

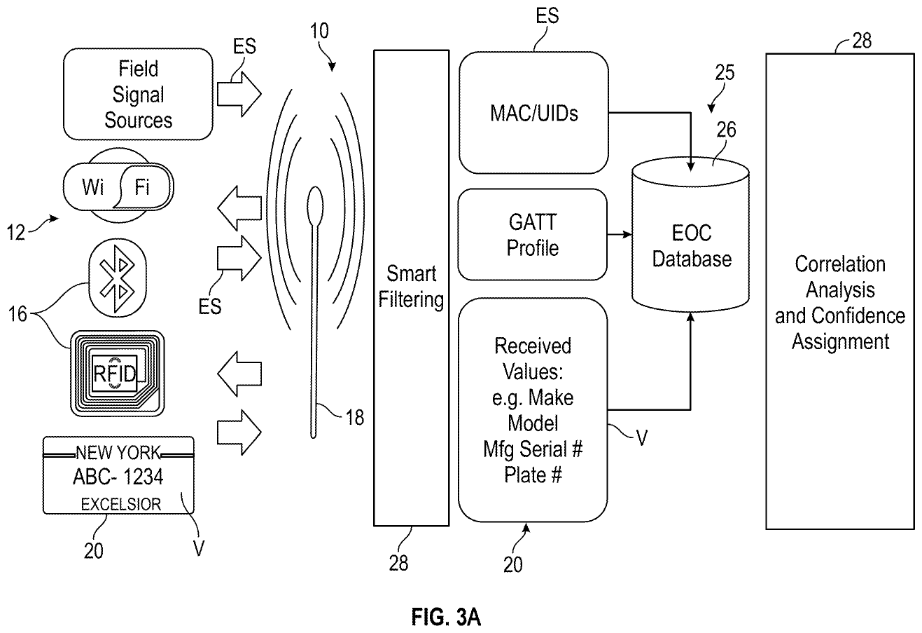

FIGS. 1, 2, and 3A provides a schematic diagram of example embodiments of a surveillance system 10 for collecting and correlating electronic signal signatures and/or visual identifier information with targets, such as vehicles, individuals, devices or the like, to build intelligence databases that facilitate electronic surveillance, identification and associating indications of common location and movement of targets throughout selected geographic areas or locations at specified times.

“Electronic surveillance,” as used herein, refers to the collection and correlation of electronic signal information that can be used to identify movements of electronic devices, and potentially individuals and vehicles associated therewith. Some electronic devices transmit information that uniquely identifies them. Others transmit data that can be received repeatedly over time such that the content, format or pattern of transmission can provide enough identification data/a signature to be able to resolve identity to a reasonable specificity. The combination of electronic device signal patterns also can be consolidated to identify collections of electronic devices travelling with an individual or vehicle such that the collection pattern itself can identify the source and/or an individual or vehicle associated or correlated with the electronic device(s) with statistically significant specificity. The electronic devices' transmissions can be classified into groups of technology and frequency ranges. Cellular, Navigation, Bluetooth, Wi-Fi, RFID, Keyless entry, medical device, and tracking tags all typically transmit data that can be collected and correlated as needed.

In accordance with embodiments of the present disclosure, the surveillance system 10 will be adapted to utilize existing Wi-Fi network connectivity at a remote or selected location, such as in residential areas around homes or in neighborhoods, as well as at or around businesses and other locations or selected locations. The introduction of home automation systems, wireless security systems, and other integrated electronic devices for managing home electronics and systems, provides an opportunity to integrate collection of electronic signal data for enhancement of security applications in residential/home environments. For example, devices like Ring® video doorbells and integrated garage door openers as well as home portal systems provide a platform for monitoring and collecting internal and video events. Some of these devices apply video analytics, but still must generally rely on lighting and visibility of faces and objects.

The addition of electronic surveillance aspects provided by the surveillance system of the present disclosure is less intrusive than off-site video processing for facial or other recognition and can enable collection of data for analysis that could identify individuals even masked or in the dark. The electronic signals can be used to match with other locations, some of which might include better video or identity markers that would allow coordinated mapping of the intruder to a specific individual. At rest, however, the data is anonymous and low risk with respect to unwanted privacy intrusion. When mapped at the broader data collection levels by authorized or law enforcement staff, useful correlations of data points emerge. The concept of a neighborhood watch thus could be extended to electronic collection, and the timing and identity of deliveries, visitors or intruders could be tracked, monitored and reported, without the need for complex or expensive facial, image or license plate recognition. For example, during the holidays, more frequent and later deliveries can be made to homes, while at the same time, more thefts of packages can occur; and the surveillance system of the present disclosure thus can provide for monitoring and identification of delivery persons versus thieves and can provide law enforcement with a means for identifying and tracking such perpetrators.

In embodiments, the surveillance system is configured to enable advanced correlation searching, including correlation analysis that can incorporate/utilize a series of methods, models and processes for the correlation of identifying-characteristics and/or identifiers including license plate, electronic signals, and visual idiosyncrasies, such that an operator can use known factors to identify previously unknown factors or can use patterns of activity, identifying information, electronic signals or visual idiosyncrasies to draw conclusions about the vehicles location, association to persons, association to locations and/or travel patterns. The surveillance system thus enables an operator to use known factors to identify previously unknown factors or use patterns of activity, identifying information, electronic signals, or visual idiosyncrasies to draw conclusions about the vehicle's location, association to persons, association to locations and/or travel patterns. Using these known patterns and/or associations, the system may form a convoy for different sets of targets and/or electronic signatures. In such embodiments, the introduction of a new or atypical target and/or electronic signature may indicate an event or may enable the system to cross-check such an introduction against reported events.

In embodiments, the surveillance system can leverage existing Wi-Fi network connectivity by utilizing a plurality of collection systems or devices. The plurality of collection systems or devices may be included in the surveillance system. The collection systems or devices will include a plurality of sensors or detectors, for example, including Bluetooth and Wi-Fi collection source devices (e.g., to gather data relating to such signals), a cell phone collection application or device, a LPR or ALPR, a video or image capture device, and/or another device or set of sensors to capture different types of signals or identifiers. Such collection systems or devices can be located on mailboxes, home entrances, driveways, and signage such that the collected electronic signature data could show the transition of vehicles and people through neighborhoods and properties. The plurality of collection systems may gather or receive signals from a number of sources, such as a garage door opener, video doorbell, security cameras, motion detectors, home automation devices, smart devices, key fobs, computing devices, home/business Wi-Fi, gaming systems, cellular devices, and/or other devices at a home that generate an electronic signal. In addition, by placing devices at tactical locations on a property, the devices could collect a range of signals for central communication and storage.

In a further embodiment, the plurality of collection systems may be, in addition to or rather than being separate systems or devices, included in or be a part of the number of sources. For example, at least one of the plurality of collection systems or device can include or can be integrated with (e.g., may be included in or a part of) a garage door opener, video doorbell, security cameras, motion detectors, home automation devices, smart devices, key fobs, computing devices, home/business Wi-Fi, gaming systems, cellular devices, and/or other devices at a home that generate an electronic signal.

Based on the received electronic signals and/or targets, the surveillance system may generate a convoy or group of targets or signals for a selected location. In such embodiments, the surveillance system may determine the convoy. In such examples, the convoy may include data relevant to each part of the convoy. Further, additional signals for the convoy may not be recorded, thus reducing the amount of data stored in the surveillance system. Further, using the convoy, the surveillance system may determine whether a new target or electronic signal is a part of the convoy or atypical or different than normal. The identification or discovery of the new target and/or electronic signal may indicate an event is occurring or has occurred. Based on such an occurrence, an alarm may be generated.

In embodiments, the surveillance system can filter and sort results such that the user is directed to signals most likely to have originated from the same set of devices travelling together. “Signals” here can mean electronic signals, visual identifiers, or license plate identification. In addition, the use of the transmitted methods and features of an electronic source with respect to signal strength, advertised methods, order of advertised elements, public and private attributes, and/or signal spectrum utilization by the surveillance system, as described further herein, can be used to collectively identify that source relatively distinctly.

In embodiments of the methods disclosed herein, the method(s) can incorporate correlation confidence assignment whereby correlated results between electronic signatures and targets are analyzed using factors such as a frequency of occurrence, relative representation, signal type, signal receipt location diversity and signal strength profiling to generate and present confidence levels for correlations between signal-receipt events. The methods further will use correlation statistics and analysis to develop relationships between identifiers and non-unique characteristics, such as frequency of identifications, and other factors, captures/associated over multiple encounters.

No single factor is required to be an absolute or unique identifier. In some embodiments, for example, captured signals or factors can be related to locations that could also be correlated or associated with other factors such a set of captured license plates, witness statements, etc. The cross-correlations also can be broken into subsets for filtering and generating confidence in the results of such advance correlation searching. The combination of non-unique characteristics and broadcast or visible variables, methods and transmitted values are used to identify a set that are collectively statistically significant in their unique association with the source entity.

In other embodiments, the method can include correlation data noise-reduction at a collection point for filtering in-coming electronic signals to maximize the receipt and storage of moving, stable, identifiable signals by analyzing the signal value, strength, spectrum and embedded identification data. The method also can substantially simultaneously reduce and filter signals and identifiers that are ‘noise’ from likely-unrelated sources and not relevant to the future correlation.

As indicated in FIG. 1, the surveillance system 10 includes a plurality of collection systems, devices or assemblies 12 that are located at selected geographic areas or strategic/targeted locations about a property such as a residential or commercial property 5, e.g., on a mailbox, post, gutter, adjacent a camera, other locations on a house or building, etc. (as indicated at 13 in FIG. 1). The collection systems generally will be configured to capture or facilitate collection of information related to visual identifiers and/or electronic signal signature information from nearby transmitting electronic devices 14 associated with targets. The targets generally will include persons, vehicles, or a combination of both in and/or moving about the selected areas or locations. Targets also can include transmitted electronic devices or other objects and/or electronic devices associated with a specified person, without departing from the scope of the present disclosure. The collection systems can be positioned at various locations or collection points about a specific geographic area, e.g., a nearby or proximate to a home, a business, and/or neighborhood, or combinations thereof.

FIGS. 1-3A further show an embodiment wherein each collection system includes a sensor or sensor assembly 16 configured to collect or otherwise capture the information related to visual identifiers and/or electronic signatures of targets. The sensor or sensor assembly accordingly can include one or more antennae 18 for capture of various electronic signals “ES” (FIGS. 1 and 3A); and/or one or more cameras or camera systems configured to capture or facilitate collection of information related to vehicle identifiers “V”, such as visual or image information (e.g. video or photographic or digital images) related to a license plate of a vehicle and/or other visual vehicle or personal identifiers that can be used to discern, detect and/or otherwise identify or confirm the identity of a target vehicle or person.

For example, in some aspects, such as shown in FIGS. 1 and 3A, such vehicle markings can include, but are not limited to, signage, stickers, bumper stickers, non-license plate tags, patterns, position or configuration of component parts, damage to the vehicle, such as scratches, dents, repair marks, etc. and the location thereof on the vehicle, small markings or symbols or other indicia on vehicle components, as well as various other identifiable visual markings, or combinations thereof. In some embodiments, the camera system also can include an Automated License Plate Reader (“ALPR”) 20 integrated or otherwise associated with a collection system, or the surveillance system can include ALRPs in addition to, or in place of, one or more collection systems.

In addition, or in the alternative, the at least one sensor or sensor assembly also can include an antenna, antenna array, or plurality of antennas 18 configured to capture or otherwise receive electronic signals from transmitting electronic devices associated with the targets for identification/extraction of electronic signatures. The at least one sensor or sensor assembly can include additional sensors, such as IR sensors or other light sensors, without departing from the present disclosure.

As further illustrated in FIG. 1 in some non-limiting example embodiments, the transmitting electronic devices 14 can include, but are not limited to, transmitting electronic devices associated with a vehicle, such as vehicle components including, but not limited to, tire pressure sensors or other manufacturer installed or after-market vehicle sensors, vehicle stereo or entertainments systems, vehicle navigation systems, vehicle infotainment systems, self-driving or driver assist vehicle guidance systems, vehicle Wi-Fi hotspots, other components of internal or external vehicle systems, etc. . . . ; and additionally can include transmitting electronic devices associated with persons or other types of targets, including, but not limited to, cellular phones and/or other communication devices, tablets, laptops, smart watches, fitness trackers, wireless headphones, RFID tags (e.g., key cards, library books, assets tags, pallet transmitters, pet collars), Wi-Fi hot spots, home automation devices, smart home devices, a garage door opener, a security camera, a doorbell camera, and/or other personal electronic devices. Each sensor or sensor assembly is configured to capture or collect signals transmitted by or otherwise emanating from the transmitting electronic devices when the targets get within proximity of the collection systems.

The collection systems also can be configured to receive signals within a collection range, for example, and not limiting, within a prescribed or selected proximity in relation thereto. For example, in some embodiments, the collection systems could be configured to look for and receive signals transmitted within about 200 feet of the collection systems; while in other embodiments, such as to reduce or limit extraneous noise or to help filter such noise, shorter ranges of signals also can be used, i.e. in some locations, the collections systems can be configured to receive signals transmitted within about 100 feet of the collection systems, and in still other embodiments or locations, signals transmitted within about 50 feet of the collection systems. Other, varying ranges also can be used.

In addition, as indicated in FIG. 1, the surveillance system includes an intelligence system that is in communication with the plurality of collection systems. The intelligence system 25 is configured to receive information collected or captured by the collection systems and to identify and/or track targets or correlate a target with other targets or electronic devices and/or locations based on this received information. The intelligence system can be in wireless communication with the collection systems, e.g., through a public or private network using Wi-Fi, cellular, etc. . . . . In addition, or in the alternative, the intelligence system and one or more of the collection systems can be connected through one or more wired connections. In this regard, when targets come within proximity of the collection systems, the collection systems will collect visual information and/or electronic signal information associated with the targets and transmit data points or packets of information, e.g., time and location stamped information, related to collected visual and/or electronic signal information to the intelligence system.

The collection systems can include communications circuitry (e.g., one or more transmitters, receivers, etc.) 22 configured to transmit data points or packets substantially simultaneously or generally in real time when targets come within proximity to the collection systems. For example, the collection systems can send one or more data points including information corresponding to each electronic signal or visual identifier as it is captured or can send a data packet including information corresponding to multiple electronic signals or visual identifiers received. In addition, or in the alternative, the collection systems can transmit the data points or packets at specific time intervals, such as every few seconds, minutes, hours, etc. or at other times or intervals after the electronic signals or visual identifiers are captured, without departing from the scope of the present disclosure.

In addition, in embodiments such as indicated in FIG. 1, such electronic signal data can be collected by a cellular device 23, such as a cell phone, tablet, etc. running an application configured for collection of such electronic signal data. Alternatively, one or more of the collection devices or systems can include a wireless model or cellular connectivity for transmission of the captured electronic signal data. For example, a series of collection devices can be linked or networked together to a master collection device that receives, compiles and transmits the data received from the other localized collection devices connected thereto to an intelligence system 25 that can be accessed by law enforcement. As a further alternative, the collection device(s) can be linked to the home or business Wi-Fi network for transmission of the collected electronic signal data.

FIGS. 1-3C further show that the intelligence system 25 will include correlation and search capabilities or one or more correlation and search engines 28 or circuitry (FIG. 3A) and an intelligence database 26. The correlation and search engine 28 or circuitry is configured to identify or extract electronic signatures and/or other targets associated with a target using collected visual and/or electronic signal information at the collection systems. In particular, the correlation and search engine(s) 28 or circuitry is configured to ingest or process the data points/data packets to associate or correlate the visual identifiers with the received electronic device signals and/or other visual identifiers of other targets to facilitate the identification or extraction of electronic signatures and/or other targets identifying the targets. In such embodiments, such an association or correlation can be utilized by the correlation and search engine 28 or circuitry to create a convoy or, in other words, a group of targets which may travel together at varying times on varying dates and/or at varying locations (e.g., typical or atypical locations that a target or convoy may be traveling in proximation thereto).

In an embodiment, the intelligence system 25 or intelligence device and/or the correlation and search engine 28 or circuitry further may include a memory and a processor or one or more processors. For example, as illustrated in FIG. 3B, the surveillance system 100 may include an intelligence device 102 and the intelligence device 102 may include a memory 104 and a processor 105, as well as a correlation engine 106. The memory 104 may store instructions executable by the processor 105 or one or more processors. In an example, the memory 104 may be a non-transitory machine-readable storage medium.

As used herein, a “non-transitory machine-readable storage medium” may be any electronic, magnetic, optical, or other physical storage apparatus to contain or store information such as executable instructions, data, and the like. For example, any machine-readable storage medium described herein may be any of random access memory (RAM), volatile memory, non-volatile memory, flash memory, a storage drive (e.g., hard drive), a solid state drive, any type of storage disc, and the like, or a combination thereof. As noted, the memory 104 may store or include instructions executable by the processor 105.

As used herein, a “processor” may include, for example one processor or multiple processors included in a single device or distributed across multiple computing devices. The processor may comprise at least one of a central processing unit (CPU), a semiconductor-based microprocessor, a graphics processing unit (GPU), a field-programmable gate array (FPGA) to retrieve and execute instructions, a real time processor (RTP), other electronic circuitry suitable for the retrieval and execution instructions stored on a machine-readable storage medium, or a combination thereof.

In embodiments, the instructions executable by the processor may include instructions to retrieve data or signals continuously, substantially continuously, or at specified intervals from one or more collection devices 108A, 108B, and up to 108N. Each of the one or more collection devices 108A, 108B, and up to 108N may include at least one sensor 110A, 110B, and 110N and a communications circuitry 112A, 112B, and 112N, respectively. Each of the one or more collection devices 108A, 108B, and up to 108N may further include at least one antenna. The intelligence device 102 may send a request for data or signals and/or scan for data or signals. For example, if a collection device is detected, the intelligence device 102 may connect to or scan the communications circuitry of that collection device and collect the data or signals associated with the collection device. The instructions also may include instructions to correlate captured signals to one or more of targets, convoys, and/or locations, as described herein. In embodiments, the instructions may further include instructions to generate an interface or graphical user interface (GUI) enabling a user to search and filter received and correlated data or signals. Other instructions may be included in the memory to perform the functions described herein. In an embodiment, the instructions described above may be included in or may be a correlation engine 106 of the intelligence device 102.

As used herein, “signal communication” refers to electric communications with/from electronic devices, such as by hard wiring two components together or wireless communication, as understood by those skilled in the art. For example, wireless communication may be Wi-Fi®, Bluetooth®, ZigBee, and/or forms of near and/or far field communications. In addition, signal communication may include one or more intermediate controllers or relays disposed between elements that are in signal communication with one another.

In embodiments, the electronic signatures can include information related to the collected electronic signals of the transmitting electronic devices or combinations of collected electronic signals of the transmitting electronic devices that uniquely identify the targets. For example, and without limitation, a combination of one or more signals from a plurality of transmitting electronic devices (e.g., a watch, cell phone/communication device, headphones, etc.) can include an electronic signature that uniquely identifies a person; a combination of one or more signals from a plurality of transmitting vehicle components (e.g., a vehicle sensor, infotainment system, etc.) can include an electronic signature that uniquely identifies a vehicle; a combination of one or more signals from a plurality of transmitting home or business components (e.g., a garage door openers, computing devices, video doorbells, etc.) can include one or more electronic signatures that uniquely identifies a home or business, which may or may not include vehicles; or one or more signals from a transmitting electronic device can include an electronic signature that uniquely identifies that electronic device.

In embodiments, such signals may include data unique to a device, as well as anonymous. While such signals may, in some embodiments, not specify a user or person (e.g., anonymous), the correlation and search engine may be configured to associate such signals with a target based on known previously captured signals and/or may be configured to generate a target based on those signals. For example, the collected signals can be identified as relating to a certain type of signal and/or a certain type of device, and can be correlated with other identifying signal information to develop an electronic signature for the electronic device, which electronic device can be associated with a target and later identified by comparing additional collected electronic signals to those of a machining electronic signature for a device or devices associated with a target.

The correlation and search engine further can be configured to filter or otherwise alter the received electronic signatures (or information related thereto) to reduce or diminish signal noise (e.g., from a noisy signal) and facilitate identification or extraction of unique, identifying electronic signatures. For example, the correlation and search engine can apply filtering (e.g., linear or non-linear filters, dynamic noise reduction, etc.) to collected noisy electronic signals to diminish, reduce, or substantially eliminate stationary and variable noise and other values that cannot be usefully correlated with targets, allowing unique electronic signal values to be extracted or identified.

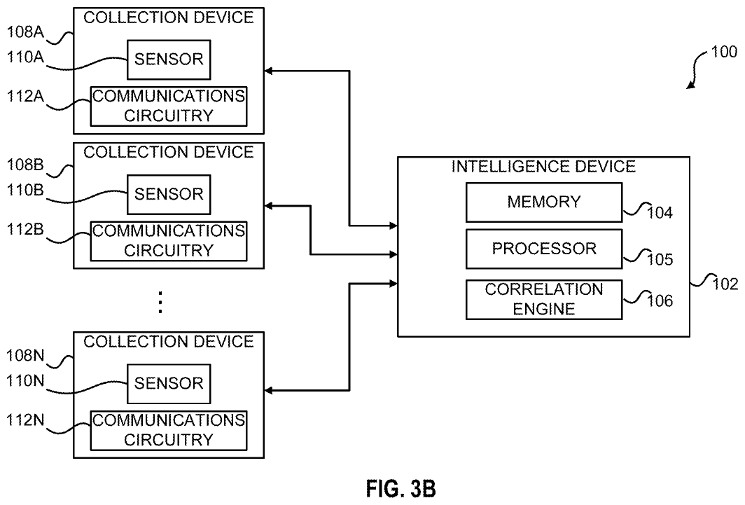

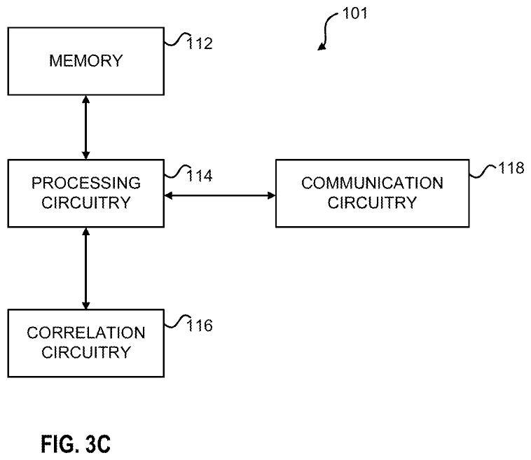

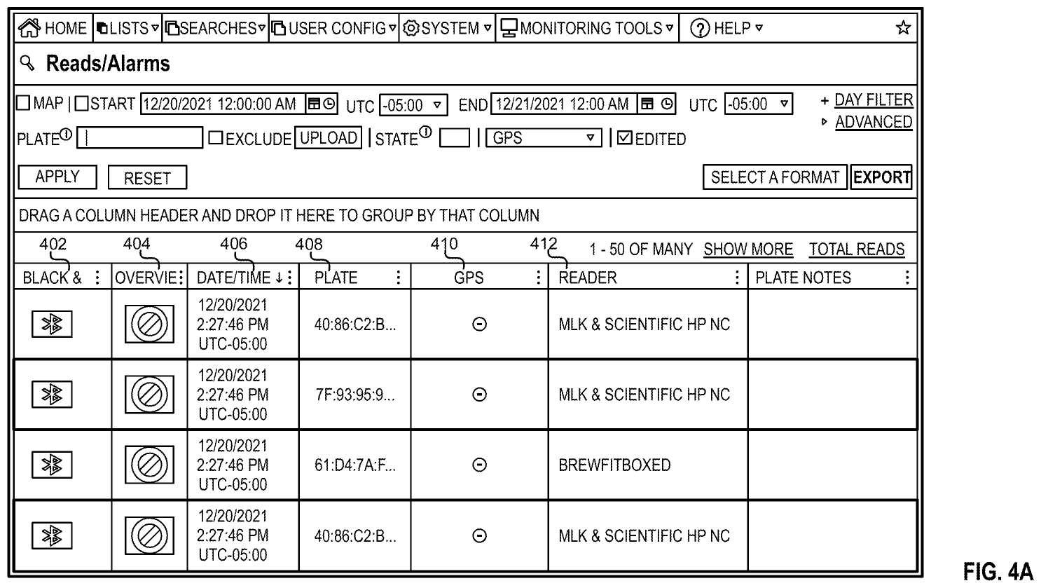

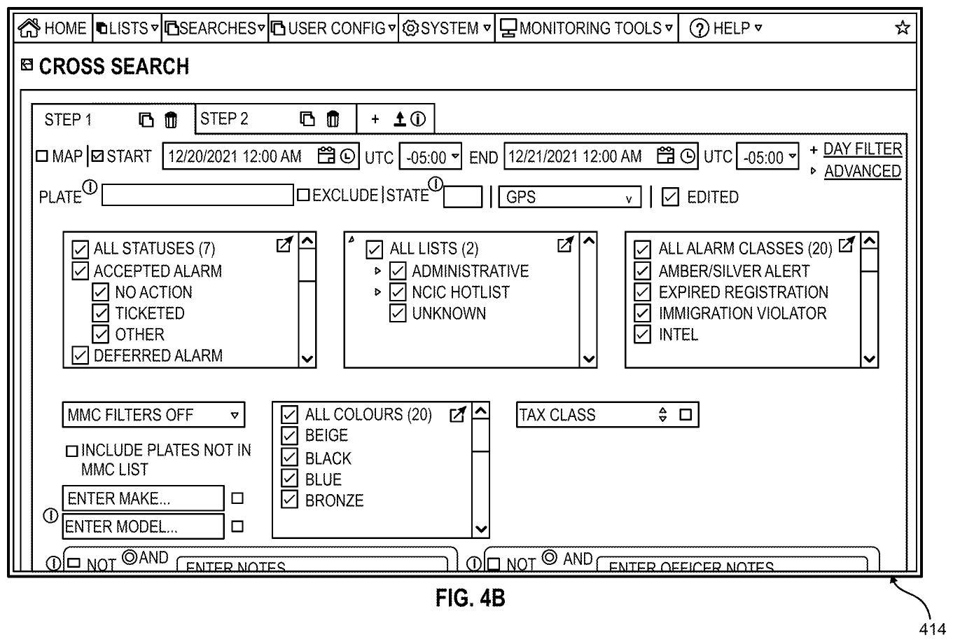

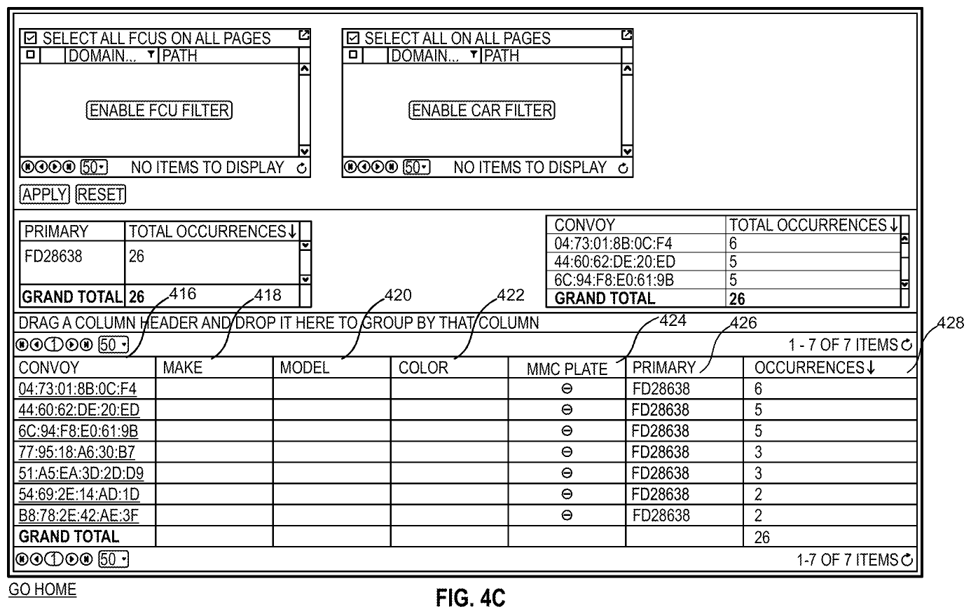

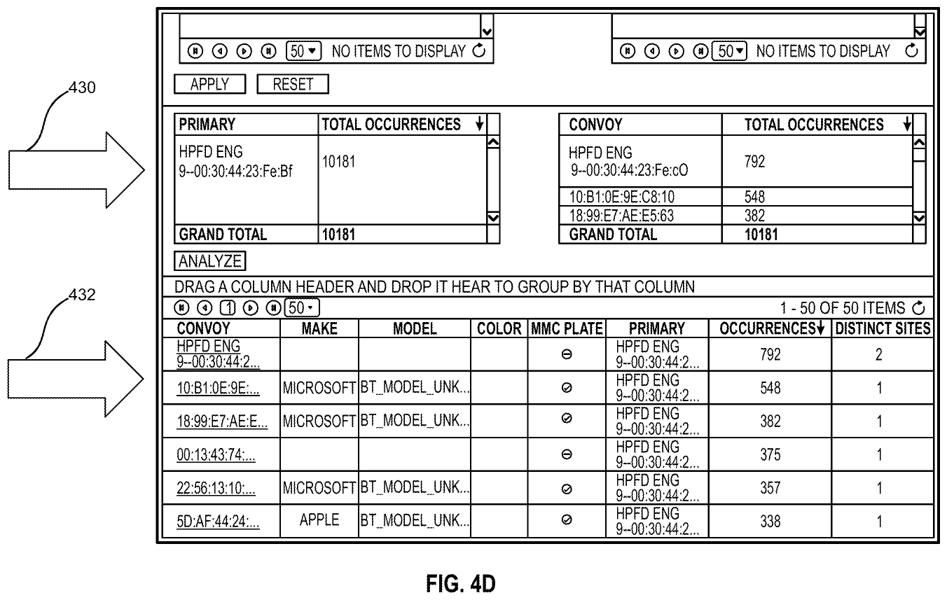

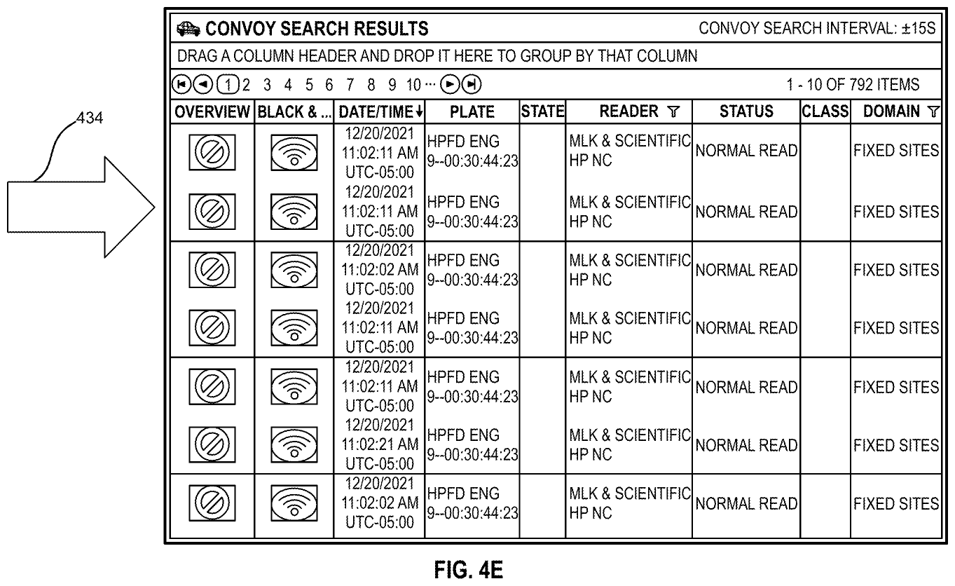

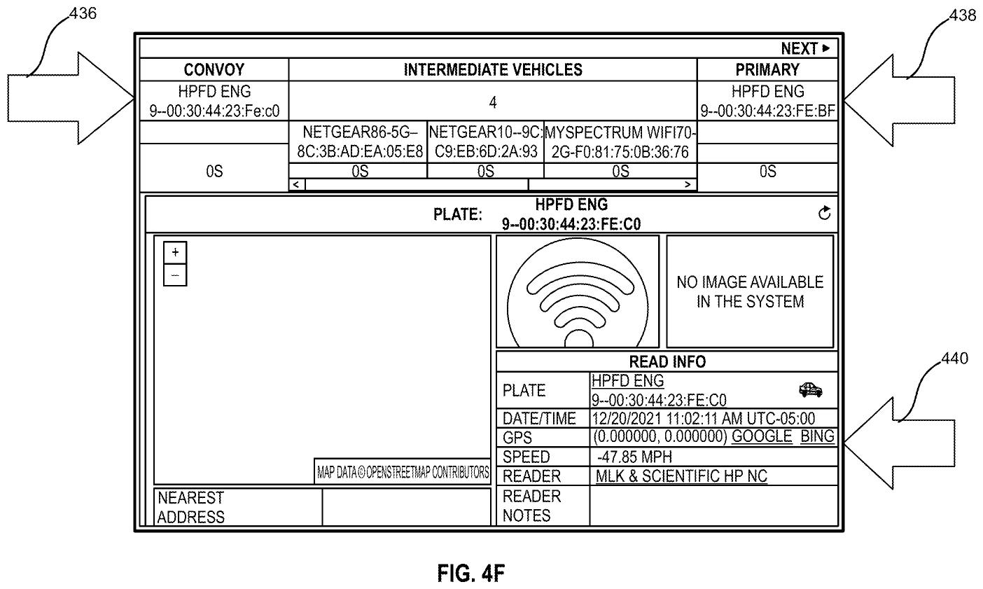

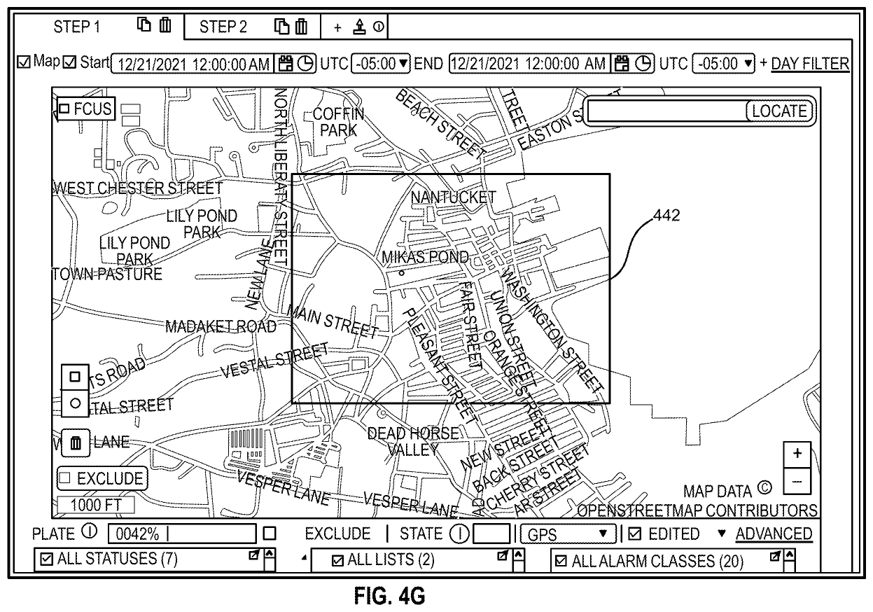

As further shown in FIG. 3C, in an embodiment, the surveillance system 101 or apparatus may include processing circuitry 114, memory 112, communications circuitry 118, and correlation circuitry 116, each of which will be described in greater detail below. While the various components are illustrated in FIG. 3C as being connected with processing circuitry 114, it will be understood that the system 101 or apparatus may further comprise a bus (not expressly shown in FIG. 3C) for passing information amongst any combination of the various components of the surveillance system 101 or apparatus. The surveillance system 101 or apparatus further may include programming or instructions configured to execute various operations described herein, such as those described above in connection with FIGS. 1 through 3B and below in connection with FIGS. 4A through 4G.

The processing circuitry 114 (and/or co-processor or any other processor assisting or otherwise associated therewith) may be in communication with the memory 112 via a bus for passing information amongst components of the surveillance system 101 or apparatus. The processing circuitry 114 may be embodied in a number of different ways and may, for example, include one or more processing devices configured to perform independently. Furthermore, the processing circuitry 114 may include one or more processors configured in tandem via a bus to enable independent execution of software instructions, pipelining, and/or multithreading. The use of the term “processor” may be understood to include a single core processor, a multi-core processor, multiple processors of the surveillance system 101 or apparatus, remote or “cloud” processors, or any combination thereof.

The processing circuitry 114 may be configured to execute software instructions stored in the memory 112 or otherwise accessible to the processing circuitry 114. In some cases, the processing circuitry 114 may be configured to execute hard-coded functionality. As such, whether configured by hardware or software methods, or by a combination of hardware with software, the processing circuitry 114 represents an entity or device (e.g., an element that can be physically embodied in circuitry) capable of performing operations according to various embodiments of the present invention while configured accordingly. Alternatively, as another example, when the processing circuitry 114 is embodied as an executor of software instructions, the software instructions may specifically configure the processing circuitry 114 to perform the algorithms and/or operations described herein when the software instructions are executed.

The memory 112 may be a non-transitory machine readable storage medium and may include, for example, one or more volatile and/or non-volatile memories. In other words, for example, the memory 112 may be an electronic storage device (e.g., a computer readable storage medium). The memory 112 may be configured to store information, data, content, applications, software instructions, or the like, for enabling the apparatus to carry out various functions in accordance with example embodiments contemplated herein.

The communications circuitry 118 may include at least one device or circuitry embodied in either hardware or a combination of hardware and software that is configured to receive and/or transmit data from/to a network and/or any other device, circuitry, or module in communication with the surveillance system 200 or apparatus (e.g., one or more collection devices). In this regard, the communications circuitry 118 may include, for example, a network interface for enabling communications with a wired or wireless communication network. For example, the communications circuitry 118 may include one or more network interface cards, antennas, buses, switches, routers, modems, and supporting hardware and/or software, or any other device suitable for enabling communications via a network. Furthermore, the communications circuitry 118 may include the processing circuitry for causing transmission of such signals to a network or for handling receipt of signals received from a network.

The surveillance system 101 or apparatus generally will include a correlation circuitry 226 configured to obtain and/or receive data and/or signals from one or more collection devices, identify and/or develop electronic signatures based on the data and/or signals, and/or correlate the data and/or signals or the electronic signature to a target, convoy, location, event, and/or other aspect. For example, the surveillance system 101 or apparatus may scan for various signals (e.g., via Wi-Fi, Bluetooth, etc.). Once a signal is detected, the correlation circuitry 116 may request or obtain data and/or signals from the collection device emanating the signal. Once the correlation circuitry 116 obtains or receives the data and/or signals, the correlation circuitry 116 may identify and/or develop an electronic signature or identifying electronic signature based on the data and/or signals.

The electronic signature or identifying electronic signature may be based on various aspects of data and/or signals, such as the type of data and/or signal, a device associated with the data and/or signal, number of times or frequency that the data and/or signal has been detected, location associated with the data and/or signal, among other aspects. The correlation circuitry 116 may correlate the electronic signature or identifying electronic signature with one or more of a target, convoy, location, event, and/or other aspect. In an example, the correlation circuitry 116 may determine whether the data and/or signal or the electronic signature or identifying electronic signature is associated with a known or unknown target or convoy and/or whether a target or convoy is in a typical or atypical location. In a further embodiment, the correlation circuitry 116 may generate an alarm, to be transmitted to one or more users, when an unknown target is detected or when a target is in an atypical location. The correlation circuitry 116 may store the results of the correlation, as well as other information related to the data and/or signal, in a database. The correlation circuitry 116 may generate a user interface enabling a user to search through and/or filter the results.

In addition, and as depicted in FIGS. 4A-4G, the correlation and search engine is configured to catalogue the electronic signatures and/or visual identifiers in the intelligence database with specific identifying characteristics allowing these identified electronic signatures and/or visual identifiers to become unique, identifiable, and searchable. The identifying characteristics can include, but are not limited to, geographical coordinates, time stamps, source manufacturer, source type and unique ID, etc. . . . . The correlation and search engine also can be configured to build catalogs or groupings of independent data points/data packets in the intelligence database that allow correlation analysis to show what otherwise anonymous or non-unique electronic signals and/or other visual identifiers (e.g., other license plates) consistently appear with the targets.

“Cluster Analysis” can be utilized to associate signal occurrences that follow a pattern, and the system may dynamically generate associations between the signals in a sample. Cluster analysis can allow new signal patterns to generate new cluster identities and for additional signals to be associated with that cluster when the system identifies the cluster-defining pattern. Further, the cluster analysis then allows otherwise anonymous signals to be categorized to a level of uniqueness that the surveillance system modeling/algorithms can use to identify the source with a confidence of uniqueness based on the presence of signals matching one or more cluster. The cluster-defining pattern criteria may include, but are not limited to, identifying information, content structure, transmission pattern, transmission size, encrypted content structure or content variation.

The surveillance system thus can identify, track, map, catalogue, etc., the presence and/or movements of the targets, in real time for a particular convoy, as electronic signals emanating therefrom occur in proximity to the collection systems or based on image captures of visual identifiers. The surveillance system further can generate alerts or notifications when certain targets (e.g., atypical or unknown) are in proximity to the collection systems. Still further, the surveillance system further allows for the searches or queries of the intelligence database, e.g., for investigating locations or movements of suspects or other persons of interest. The surveillance system, as noted, can generate alerts or notifications when selected known targets are in proximity to the collection systems and, further, initiate home automation systems based on such an alert or notification.

In embodiments, the correlation and search engine can use algorithms, models, statistical models, machine learning algorithms/models, Big Data analysis or statistics, cluster analysis, etc., to infer relationships between transmitting electronic devices and/or targets based on consistency or likelihood of correlation of the visual identifiers and/or electronic signals of the transmitting electronic devices. For example, the correlation and search engine can be configured to evaluate and combine singular collection events at the collection systems with other catalogued events in the intelligence database to develop correlated information related to the intersection of multiple collected/captured electronic signals and/or visual identifiers that occurred at a specific time and geographical area or location. And, the correlation and search engine can use the frequency and/or consistency of electronic signals and/or visual identifiers received at collection systems to determine the relative certainty of association of the transmitting electronic devices and/or targets to develop electronic signatures (correlated electronic devices) or correlated targets (e.g., correlated license plates) for the targets.

By way of example and not limitation, the system can identify high confidence correlations in which a set of signals entering the receiving range of a residence to indicate the arrival of the owner and/or a known vehicle. This might be used to trigger home automation (e.g., open a garage door, turn on specified lights, etc.) or to reduce the level of threat assessment being monitored at the previously vacant residence (e.g., a target is known and, for example, signals associated with the target may not be monitored for a specified time period, such as while the owner is home, after initial identification). As an additional example, the system might consistently see a set of signals associated with a home-owner's vehicle and the typical occupants and may classify these as having a high confidence of being correlated with the vehicle. If an additional signal begins to consistently appear with that pattern, the system may be configured to retain the new signal as ‘known’ within the correlation, or if configured for higher security, may generate or create a notification indicating that a change has occurred, thus allowing the owner to assess if a new device was acquired or if some suspicious new source has appeared. The presence of an additional new signal (e.g., a new signal which is not part of a known pattern of identification as it appears over time) may be added to a category of known devices such that its presence over time with known devices may make the new signal less likely to be considered a concern when that device appears without the other known devices.

The correlation and search engine can be programmed to determine a likelihood or probability that a specific electronic signal, a combination or set of electronic signals, and/or other target or targets are associated with a target or location (e.g., a home or neighborhood), and if the determined likelihood or probability meets a prescribed/selected likelihood or probability threshold, the engine will identify or extract an electronic signal or combinations of electronic signals as an electronic signature or electronic signatures to be associated with that target at the location. In one embodiment, the likelihood or probability threshold can be about 70% or more (e.g., above 75%, above 80%, above 85%, above 90%, above 95%, above 98%, etc.) that an electronic signal, combination/set of electronic signals, and/or other targets are associated with a particular target, convoy, and/or location.

For example, the correlation and search engine may correlate two or more license plates and one or more electronic devices based on multiple events. Based on such a correlation, a prediction of whether a particular vehicle may be present at a specific location may be determined by the correlation and search engine. Further, the two or more license plates may be from or may define a convoy (e.g., group of targets or target vehicles). In such an example, the electronic devices may be associated with the convoy.

In some embodiments, the correlation and search engine can be configured to determine or identify a location at which a visual identifier and correlated electronic signature and/or other visual identifier are matched to enable tracking and/or verification of targets at such a location. In addition, or in the alternative, the correlation and search engine can be configured to associate identifying electronic signatures and/or other visual identifiers with a location, such as a home or neighborhood, to allow for comparison between a convoy and new, atypical electronic signals. For example, once the engine has records correlating electronic signatures and/or other visual identifiers for a selected location, e.g., a license plate likely to be located at or near a specific visual vehicle identifier, associated with the specific visual vehicle identifier, e.g., a specific license plate number, the correlation and search engine will be able to detect the likely presence of a vehicle and its associated license plate without visual information of that specific vehicle, e.g., a camera may or may not be used.

In addition, or in the alternative, an existing ALPR can be modified or retrofitted to include components of the collection point systems to enable collection of electronic signals jointly with license plate reads. Further, in some embodiments, collection systems with or near cameras or ALPRs can be used in connection with collection systems without cameras or ALPRs, as indicated at 20 in FIGS. 1 and 3A.

As a result, electronic data points from less expensive collection systems can be used to provide more precise tracking than ALPR alone. That is, the lower cost collection systems can increase collection density beyond the collection of ALPR or camera records, enabling data from both collection system types to be combined to provide more detailed intelligence and increased accuracy of verification or authentication of possible targets, including providing monitoring personnel (e.g. law enforcement, security or other personnel) with an increased level of confidence of locations of potential criminals, stolen or other vehicles of interest.

Additionally, or alternatively, collection systems without cameras (or with cameras) can be positioned in areas or locations that cannot be accessed by a vehicle, such as on trains, near railways, around public buildings, etc., to enable collection of electronic signals from persons away from their vehicle, e.g., for cataloguing, tracking, mapping, etc. . . . positions or movements thereof.

The intelligence system generally includes one or more processors, controller's, CPUs, etc., and one or more memories, such as RAM, ROM, etc., in communication with the one or more processors. And, the engine can include computer programming instructions stored in the one or more memories that can be accessed and executed by the one or more processors to facilitate execution of the processes thereof, e.g., correlation of information, identification and tracking of the targets, searching of the intelligence database, etc. . . .

The correlation and search engine can process the information from the received data points or data packages to correlate the received signal information with the visual information to develop electronic signatures uniquely identifying each vehicle or person at a selected location based on the received electronic signals or combinations thereof, and also can populate the intelligence database with the signature information identifying each vehicle and/or person. As multiple license plates may be read at a time and multiple signals detected, correlation may occur when or if multiple data points exist for a particular vehicle. Operators then can search or query the intelligence database, e.g., using a user interface or GUI as shown in FIGS. 4A-4D, for identification, mapping, tracking, etc., of vehicles, people, and/or locations at specific times.

For example, in FIG. 4A, a user may search for a particular vehicle based on a license plate number or other identifier or signature in an interface or GUI. After searching for a particular license plate number or other identifier or signature, the GUI may display a type of signal 402, an image 404 (if available), a date/time stamp 406 (e.g., when the particular license plate number or other identifier or signature was last detected), a license plate number 408 (if available), a GPS based location, and/or the reader 412 or device discovering or gathering signals associated with the particular license plate number or other identifier or signature.

In FIG. 4B, a user may perform a cross-search via an interface or GUI 414. A cross-search can include searching for a particular parameter (e.g., a license plate number, a convoy, an electronics signature, and/or some other identifier) in a first step and then perform additional searches in additional steps (e.g., step 2, step 3, etc.).

In yet another example, as depicted in FIGS. 4C-4D, a user may search for a particular convoy or search based on selected characteristics of a convoy. Upon searching for a convoy, the interface or GUI may display a convoy identifier 416, the make 418 of the convoy (e.g., vehicle manufacturer, if available), the model 420 of the convoy (e.g., type of vehicle from the manufacturer, if available), the color 420 of the convoy (e.g., the color of the vehicle, if available), a license plate number 424 (if available), a primary identifier 426 or primary identifiers (e.g., an identifier for a target primarily associated with the convoy, and/or the number of occurrences 428 or detections of the convoy at one or more specified locations, among other data.

For example, as illustrated in FIG. 4D, a user may search for a primary identifier (e.g., see 430). Upon execution of the search data relating to that primary identifier may be displayed in the GUI (e.g., see 432 or 434 of FIG. 4E). Further, as illustrated in FIG. 4F, a user my select a particular convoy or instance of a detection of a convoy and view related and/or associated details with the convoy or that instance of detection of that convoy (e.g., see 436). In yet another embodiment, and as noted herein, the interface or GUI may display a map view and/or geographical view of an area. The interface or GUI may be configured such that portions of the map view and/or geographical view are selectable. For example, a user may select a point and drag a cursor in another direction to form a box (e.g., see 442). In another example, a user may draw a shape to select such a portion or utilize other actions to perform such a selection.

Summary use cases utilizing embodiments of the surveillance system of the present disclosure can include mail and package delivery notifications, transient signal schedule tracking, regular transient signal reporting to improve bus or transport arrival or departure predictability and alerts, intrusion detection, tagged pet tracking, integrated known-visitor security and lock status-change activation, occupancy trend tracking and reporting for integrated utility and energy management, customization of entertainment and lighting systems by occupancy, simplified guest arrival and security management for commercial space rentals, hotel and campus security systems, integrated video surveillance retrieval and queueing systems and other applications/uses.

By way of example only, in some embodiments, the surveillance system can be configured to capture an electronic signature and associated information from a target, and can associate such electronic signature, as well as associate other targets, and associated information with the target's identification, e.g., license plate number or other visual identifier, with the correlation and search engine, and then allow searches for or provide alerts or notifications on receipts of similar electronic signature information and/or visual identifier at one or more of the collection systems. In an embodiment, the association or correlation of two or more different license plates, which may include correlated one or more different electronic devices, may form a convoy. Convoys may be selectable, as illustrated in FIGS. 4D-4F, and/or locations for searching targets or convoys can be selectable.

The surveillance system further can be configured to allow for search inquiries or scans of one or more specific electronic signatures associated with a target or convoy or may search for a specific convoy or target associated with one or more convoys, and to provide search results including known location data points, in the intelligence database. As depicted in FIGS. 4E-4G, the search results can include maps or other images showing the collection systems that captured electronic signals associated with the one or more electronic signatures searched, e.g., indicating the selected target's or convoy's presence or movements about a prescribed location or area.

In addition, or in the alternative, the search results can include groupings or listings of search results associating the target, electronic signals, and/or convoy searched with information related to the collection systems which captured target, electronic signals, and/or convoy associated with the two or more targets and/or one or more electronic signatures searched. The grouping or listing can include images captured (e.g., images of the person, vehicle, vehicle license plate, etc.), temporal information (e.g., the date and time the visual or signal information was collected), the visual identifier (e.g., license plate number), location information (e.g., GPS coordinates, state, city, etc.), information identifying the collection point system, statues of the collection (e.g., normal read, error, etc.), etc. . . .

The surveillance system can generate an alarm or alert when the specific electronic signature(s) and/or visual identifier distinct or atypical from a convoy is captured at a selected location. The alarm may alert a user of the presence of an atypical or distinct target(s) at or near the selected location. The alarm or alert can be provided to the operator of the surveillance system and/or local authorities, e.g., law enforcement or other third parties. In some embodiments, the target can be selected based on a specific criteria associated with the target of the convoy, e.g., arrest warrant, Amber or Silver Alert, expired registration, immigration violation, etc. . . . , and when the labeled electronic signatures and/or visual identifiers are collected at one or more of the collection systems, the proper authorities can be notified.

In still further embodiments, the surveillance system further can indicate or determine changes in association or travel of suspects based on variations in electronic signatures associated with a location. For example, based on unique electronic signatures, the surveillance system can indicate whether particular individuals are or were traveling with a vehicle through or in the selected location, which can allow investigators to determine whether suspects were actually at the selected location during an event.

By way of example and not limitation, in an embodiment for analysis of electronic signature data, an initial goal is to find associations of electronic signatures and/or targets to known ALPR targets. For this, multiple locations can be used. The repeated linking of a target (e.g., a license plate) to electronic signatures and/or other targets can be the value. For example, a particular license plate can be associated with a convoy, the convoy can be associated with a list of electronic signatures, and the convoy and/or electronic signatures associated with non-LPR sites.

In some aspects, the surveillance system and the operation thereof can include the harvest or collection of values in convoy searches when a target value is unknown. Such a search can be based on a date/time, tight correlations, and/or other factors. Reading a signal simply at one site may not be valuable, but a read at two or more sites may indicate that a target is moving and may be valuable or more valuable than a single read of a potentially stationary target. Using such systems and methods described herein, a search can be quickly refined to values that are read at multiple sites and have convoy hits/correlation or association, with and/or without a plate match. A convoy can be limited by site and by multiple electronic signature reads at a series of sites, e.g., two or more successive sites.

The foregoing description generally illustrates and describes various embodiments of the present disclosure. It will, however, be understood by those skilled in the art that various changes and modifications can be made to the above-discussed construction of the present disclosure without departing from the spirit and scope of the disclosure as disclosed herein, and that it is intended that all matter contained in the above description or shown in the accompanying drawings shall be interpreted as being illustrative, and not to be taken in a limiting sense. Furthermore, the scope of the present disclosure shall be construed to cover various modifications, combinations, additions, alterations, etc., above and to the above-described embodiments, which shall be considered to be within the scope of the present disclosure. Accordingly, various features and characteristics of the present disclosure as discussed herein may be selectively interchanged and applied to other illustrated and non-illustrated embodiments of the disclosure, and numerous variations, modifications, and additions further can be made thereto without departing from the spirit and scope of the present invention as set forth in the appended claims.

What is claimed is:

1. A surveillance system comprising:
one or more collection devices positioned proximate one or more of a home business, or neighborhood, each of the one or more collection devices comprising:
at least one sensor configured to collect electronic signals from proximal electronic devices,
a communication circuitry to transmit collected electronic signals; and
an intelligence device configured to receive the collected electronic signals and comprising:
a database, and
a correlation circuitry configured to:
generate an identifying electronic signature for the proximate electronic devices from which the electronic signals are collected, and
determine a correlation between identifying electronic signatures and one of a known target or unknown target.

2. The surveillance system of claim 1, wherein one or more of the one or more collection devices further comprises one or more of a sensor or camera configured to capture one or more of an image, a series of images, or video, and wherein the intelligence device utilizes the collected electronic signals and one or more of the one or more of an image, a series of images, or video to correlate one or more of the one or more of an image, a series of images, or video with one or more of the collected electronic signals.

3. The surveillance system of claim 1, wherein one or more of the one or more collection devices is located at a known location, and wherein the intelligence device correlates the known location of the one or more collection devices with one or more of the collected electronic signals received by the one or more collection devices.

4. The surveillance system of claim 3, wherein correlation between the known location and the one or more collected electronic signals indicates a target at an atypical location.

5. The surveillance system of claim 1, wherein at least some of the one or more collection devices include a global positioning system (GPS) device for determining a location thereof

6. The surveillance system of claim 1, wherein one or more of the one or more collection devices includes an automated license plate reader (ALPR) to capture license plate numbers and/or other vehicle characteristics, and wherein the intelligence device correlates a capture license plate number with one or more of the collected electronic signals

7. A surveillance system comprising:
one or more collection devices positioned proximate one or more of a home, neighborhood, or business, each of the one or more collection devices comprising:
at least one sensor, at least one antenna; or a combination thereof, configured to collect, via a corresponding frequency, electronic signals from proximal electronic devices, and
a communication circuitry to transmit collected electronic signals an intelligence device positioned separate from the one or more collection devices and comprising:
a database, and
a correlation circuitry to:
develop an electronic signature for each of the proximal devices from which the electronic signals are collected, and
determine a correlation of each electronic signature and one or more locations of the one or more of the home, neighborhood, or business.

8. The surveillance system of claim 7, wherein the one or more collection devices are configured to tag an electronic signal based on a type of electronic device emitting the electronic signal.

9. The surveillance system of claim 8, wherein the one or more collection devices are configured to associate a timestamp and location data with each electronic signal.

10. The surveillance system of claim 7, wherein the correlation circuitry is configured to determine a correlation between the one or more different electronic signals of the collected electronic signals and one or more identified targets.

11. The surveillance system of claim 10, wherein the one or more identified targets include one or more of a convoy or a person, or a combination thereof.

12. The surveillance system of claim 10, wherein the correlation circuitry includes one or more classification and search engines configured to identify the collected electronic signals and compare identified collected electronic signals with one or more targets to determine the correlation of the one or more different electronic signals of the collected electronic signals and the one or more identified targets.

13. The surveillance system of claim 12, wherein the one or more classification and search engines are configured to determine inferences of targets typical to the one or more locations and targets atypical to the one or more locations, and wherein the correlation is based on the inferences of targets typical to the one or more locations and targets atypical to the one or more locations.

14. The surveillance system of claim 13, wherein determination of the inferences is based on one or more of reported events or reported alerts.

15. The surveillance system of claim 14, wherein the one or more of reported events or reported alerts include crimes and other events.

16. The surveillance system of claim 14, wherein the determination of the inferences is further based on detection of one of one or more electronic signals more than a preselected threshold.

17. The surveillance system of claim 7, wherein the at least one sensor comprises one or more cameras configured to capture electronic signals related to vehicle identifiers.

18. A method comprising:
collecting, via one or more collection devices positioned proximate a residential or commercial building, electronic signals from proximal electronic devices positioned at one or more of within the home or proximate the home;
reviewing the electronic signals for detection of noisy signals collected within the electronic signals;
in response to detection of noisy signals collected within the electronic signals, removing the noisy signals of the electronic signals to thereby form filtered electronic signals;
transmitting the filtered electronic signals to a database;
developing an electronic signature for each of the proximal devices from which the filtered electronic signals are collected; and
determining a correlation between each electronic signature and one or more targets based upon a comparison of each electronic signature and one or more stored electronic signals associated with the one or more targets.

19. The method of claim 18, further comprising, upon reception of the electronic signals, tagging each of the electronics signals based on a type of electronic device from which a corresponding electronic signal is collected.

20. The method of claim 18, wherein the one or more targets comprise one or more convoys or people.

21. The method of claim 18, wherein the one or more different electronic signals comprise one or more of unidentified signals or atypical signals.

22. The method of claim 18, further comprising tracking one or more targets based on the correlation.
